(19) United States
(12) Patent Application Publication
(10) Pub. No.: US 2014/0145479 A1
(43) Pub. Date: May 29, 2014

(54) SEAT DEVICE FOR A BICYCLE

(71) Applicant: Mu-Rong Li, Taichung City (TW)

(72) Inventor: Mu-Rong Li, Taichung City (TW)

(21) Appl. No.: 13/689,658

(22) Filed: Nov. 29, 2012

(51) Int. Cl. B62J 1/02

(52) U.S. Cl. CPC B62J 1/02
USPC 297/195.1

(57) ABSTRACT

A seat device for a bicycle includes a seat and a frame assembled to a bottom of the seat. The frame has a front assembling portion and two elastic arms. Each elastic arm has a first inclined segment, a connecting segment and a second inclined segment in an order from a front end to a rear end of the seat. Each first inclined segment and each second inclined segment have flat cross sections, and each connecting segment has a circular cross section. Under this arrangement, when a rider rides on an unsmooth road, a road-induced vibration is delivered to the seat; and then, the seat shifts said vibration to the frame so that the frame deforms to absorb said vibration; therefore, the rider has a lower possibility in suffering damages caused by the road-induced vibration and the comfortableness of the rider is improved as well.

### BACKGROUND OF THE INVENTION

1. Field of the Invention

The present invention relates to a seat device for a bicycle, and more particularly to an improved seat device for a bicycle which cushion the road-induced vibration for riders.

2. Description of Related Art

Cycling has become a trend all over the world. For transportation, more and more people ride bicycles to school or to work in order to make a contribution to reducing the global warming.

For recreation, people ride on the bicycles and head to the parks or other attractions at the weekends; while riding, people enjoy the gentle breeze on their faces and beautiful scenery around them; all of a sudden, the unhappiness and the pressure disappear thoroughly. For health, cycling is popular since it is not only one of the easiest exercises but also bums out the calories and improves the cardiovascular fitness of a rider.

To enjoy the delightful cycling, a bicycle seat is one of the most crucial parts for the comfortableness of the rider. While riding, the bicycle seat contacts with the rider directly and shifts the road-induced vibration to the rider. The road-induced vibration not only decreases the comfortableness of the rider, even worse, said vibration often causes severe hip, pelvis and spine damages to the rider. In order to avoid said damages, several designs are arisen to diminish the road-induced vibration; for instance, a cover of the bicycle seat is usually made of sponge or other materials that can absorb the vibration; other than that, a shock absorber may be disposed under the bicycle seat to damp the impulse. However, although the sponge cover of the bicycle seat provides the comfortableness for the rider because of its softness, its vibration-absorbing efficiency is still not enough.

A conventional seat device for a bicycle has arisen to improve the vibration-absorbing efficiency. The conventional seat device for a bicycle comprises a seat, a plastic casing and a frame which is made of metal rods. The seat is disposed on the plastic casing. The seat and the plastic casing are both disposed on the frame which has an extended portion, a fork portion and a connecting portion extending from a rear end of the plastic casing to a front end of the plastic casing. Although the conventional seat device for a bicycle increases the comfortableness of the rider and the vibration-absorbing efficiency, the vibration-absorbing efficiency is still limited because of the structure of the conventional seat device for a bicycle.

The present invention has arisen to mitigate and/or obviate the disadvantages of the conventional seat device for a bicycle; therefore, improves the riding quality for the rider by the particular specification of a seat device for a bicycle.

### SUMMARY OF THE INVENTION

The main objective of the present invention is to provide an improved seat device for a bicycle.

To achieve the objective, a seat device for a bicycle comprises a seat and a frame, the frame assembled to a bottom of the seat, the frame comprising a front assembling portion assembled with a front end of the seat, two elastic arms formed in a fork-shape extended from the front assembling portion to a rear end of the seat, each elastic arm comprising a first inclined segment, a connecting segment and a second inclined segment in an order from the front end of the seat to the rear end of the seat, each first inclined segment downwardly inclined from the front assembling portion toward each connecting segment, each first inclined segment and each second inclined segment having flat cross sections, each connecting segment having a circular cross section. Wherein, each elastic arm comprises a first curved segment and a second curved segment; one end of each first curved segment is connected to each corresponding first inclined segment; another end of each first curved segment is connected to each corresponding connecting segment; for each first curved segment, a cross section at one end of the first curved segment is flat and turns into circular gradually toward another end of the first curved segment; one end of each second curved segment is connected to each corresponding second inclined segment; another end of each second curved segment is connected to each corresponding connecting segment; for each second curved segment, a cross section at one end of the second curved segment is flat and turns into circular gradually toward another end of the second curved segment; each connecting segment has a radius of 3.5 millimeters; a cushion space is defined by the front assembling portion and the two elastic arms; the cushion space is opened and enlarged from the front assembling portion toward the two elastic arms; the seat has a front positioning member and two rear positioning members defined at the bottom thereof; each rear positioning member has a side positioning groove and a front positioning groove opened thereon; the two side positioning grooves correspond to each other; the two front positioning grooves correspond to the front end of the seat; each side positioning groove communicates with each corresponding front positioning groove; the front assembling portion is inserted into the front positioning member and the two elastic arms are selectively inserted into the rear positioning members through the front positioning grooves or the side positioning grooves; two lateral sides of each first inclined segment, each connecting segment and each second inclined segment are curved.

Under this arrangement, when a rider rides on an unsmooth road, a reaction force produced by a road-induced vibration is delivered to the seat; and then, the seat shifts said force to the frame so that the frame deforms to absorb said force; as a result, the rider has a lower possibility in suffering damages caused by the road-induced vibration and the comfortableness of the rider is improved as well.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a seat device for a bicycle in accordance with the present invention;

FIG. 2 is a perspective view of a frame of the present invention;

FIG. 3 is a side view of the frame of the present invention;

FIG. 4 is a cross-sectional view along line 4-4 shown in FIG. 2;

FIG. 5 is a cross-sectional view along line 5-5 shown in FIG. 2;

FIG. 6 is a cross-sectional view along line 6-6 shown in FIG. 2;

FIGS. 7-8 are operational views of the present invention for showing a rider sits on the seat and causes the frame to deform;

FIG. 9 is a bottom plan view of the present invention; and

FIG. 10 is a perspective view for showing the present invention is assembled to a bicycle seat post.

### DETAILED DESCRIPTION OF THE INVENTION

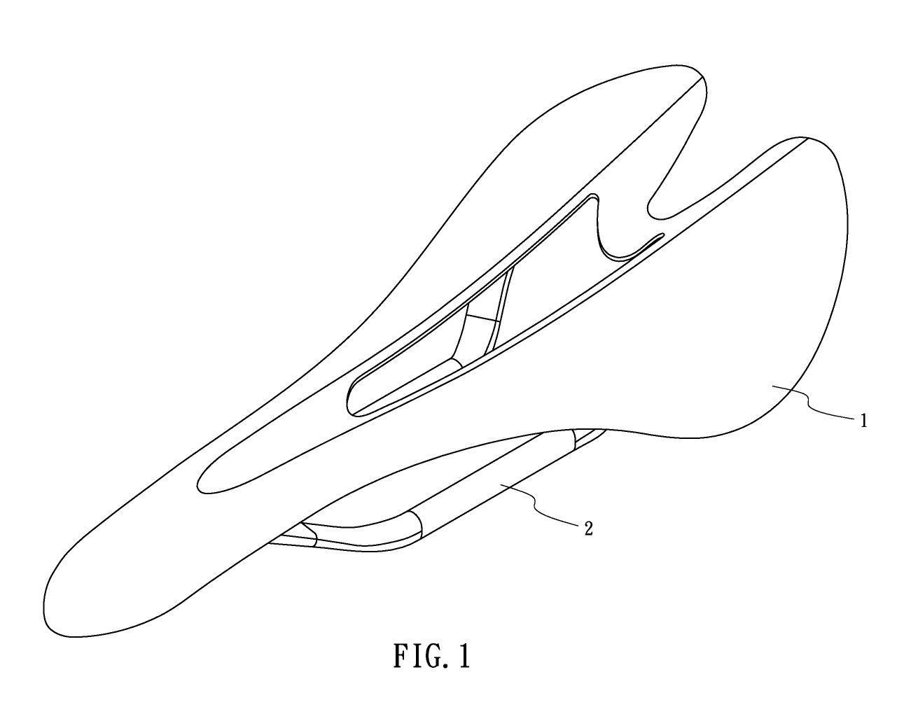

Referring to FIGS. 1-3, a seat device for a bicycle in accordance with the present invention comprises a seat 1 and a frame 2 which is assembled to a bottom of the seat 1. The frame 2 comprises a front assembling portion 21 which is assembled with a front end of the seat 1, two elastic arms 22 formed in a fork-shape extended from the front assembling portion 21 to a rear end of the seat 1. Each elastic arm 22 comprises a first inclined segment 221, a connecting segment 222 and a second inclined segment 223 in an order from the front end of the seat 1 to the rear end of the seat 1. Each first inclined segment 221 is downwardly inclined from the front assembling portion 21 toward each connecting segment 222. Each first inclined segment 221 and each second inclined segment 223 have flat cross sections and each connecting segment 222 has a circular cross section. Under this arrangement, when a rider rides on an unsmooth road, a reaction force produced by a road-induced vibration is delivered to the seat 1 firstly; then, the seat 1 shifts said force to the frame 2 so that the frame 2 deforms to absorb said force; as a result, the rider has a lower possibility in suffering damages caused by the road-induced vibration and the comfortableness of the rider is improved as well.

The advantages of the present invention are mainly arisen from the shapes of the cross sections of the first inclined segments 221 and the second inclined segments 223. Derived from the Hooke's law, a value of deformation is inversely proportional to the area where a stress is applied to; consequently, the flat cross sections of the first inclined segments 221 and the second inclined segments 223 bring the frame 2 a higher value of the elastic deformation as compared to a conventional frame which has a circular cross section. The vibration at the seat 1 is therefore dramatically reduced by the high value of the elastic deformation of the frame 2, so that the comfortableness of the rider is increased. While the first and the second inclined segments 221, 223 with flat cross sections contribute to the absorption of said vibration for the rider, the connecting segments 222 with circular cross sections provide solid support to the rider. Hence, the first inclined segments 221, the second inclined segments 223 and the connecting segments 222 together bring the rider a comfortable and satisfied riding journey.

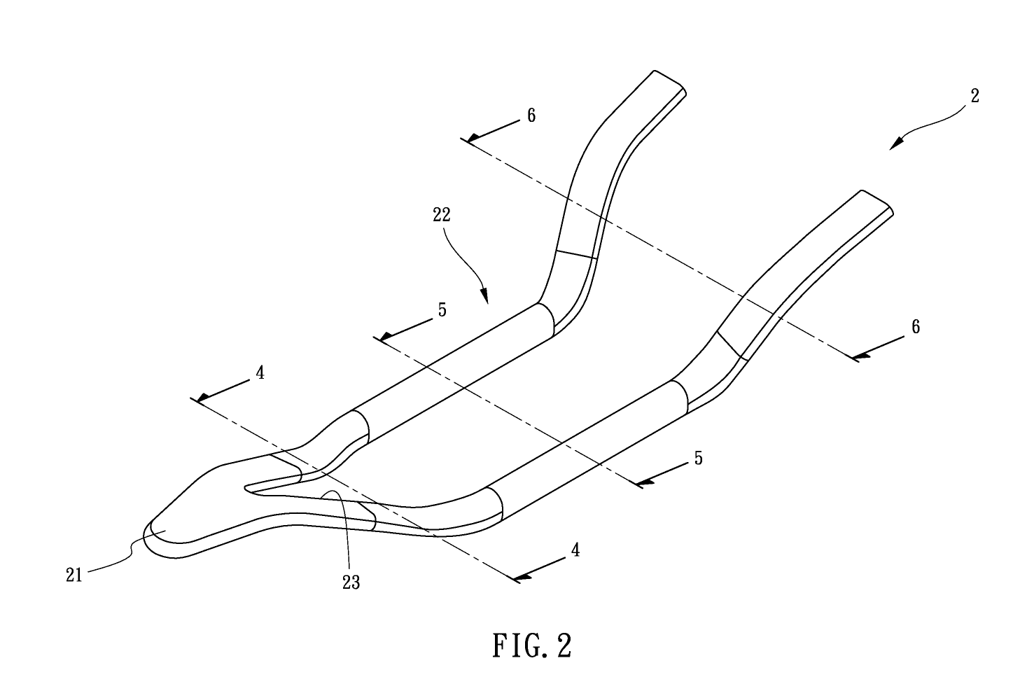

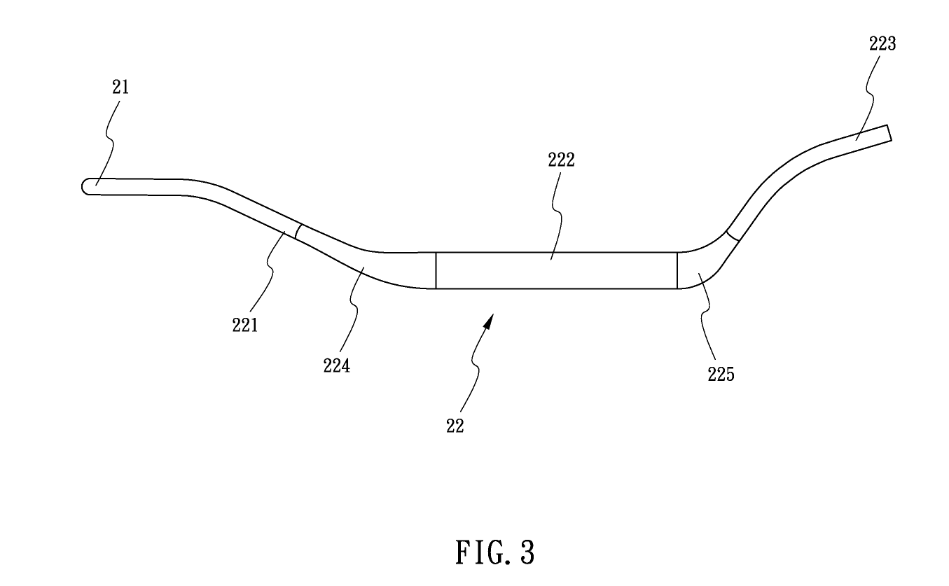

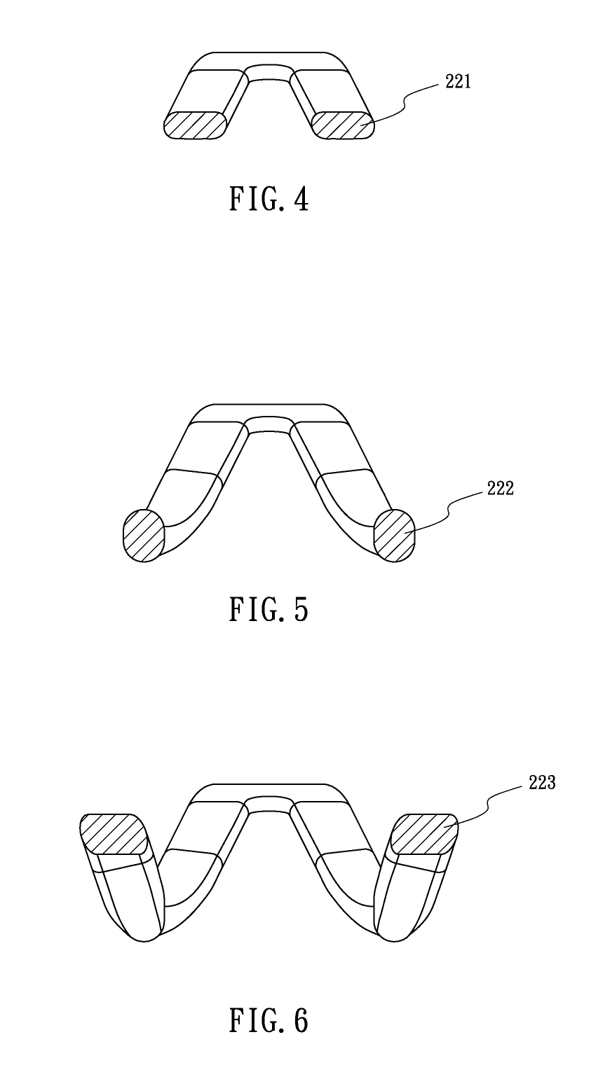

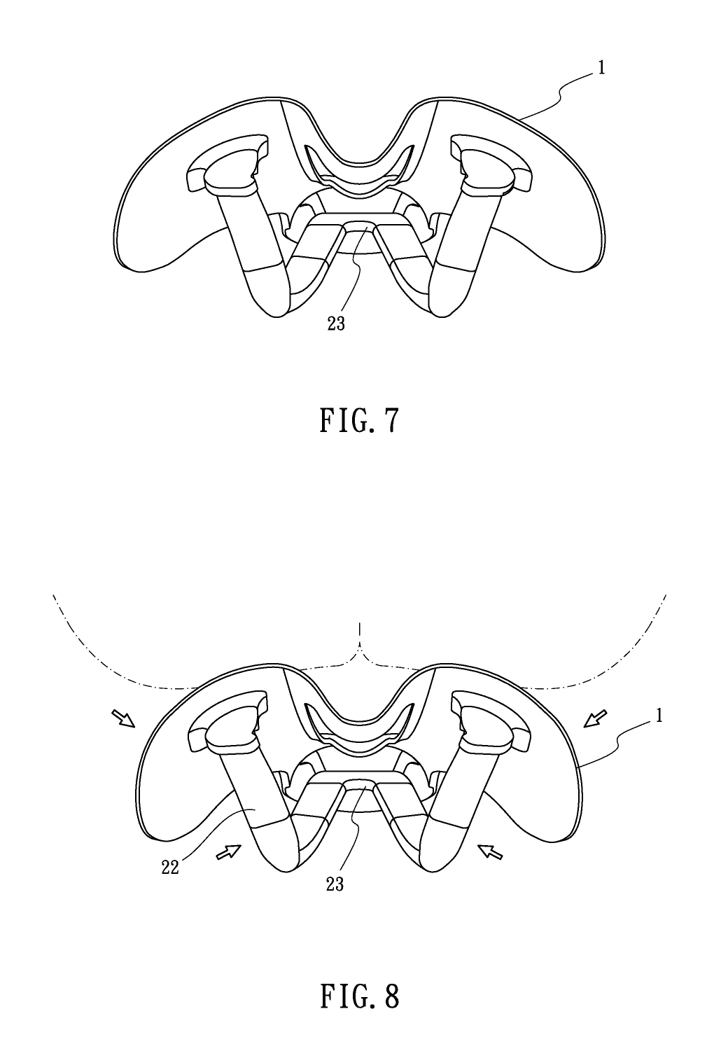

Referring to FIGS. 2-3, each elastic arm 22 further comprises a first curved segment 224 and a second curved segment 225. One end of each first curved segment 224 is connected to each corresponding first inclined segment 221 and another end of each first curved segment 224 is connected to each corresponding connecting segment 222. For each first curved segment 224, a cross section at one end of the first curved segment 224 is flat and turns into circular gradually toward another end of the first curved segment 224. One end of each second curved segment 225 is connected to each corresponding second inclined segment 223 and another end of each second curved segment 225 is connected to each corresponding connecting segment 222. For each second curved segment 225, a cross section at one end of the second curved segment 225 is flat and turns into circular gradually toward another end of the second curved segment 225. Each connecting segment 222 has a radius of 3.5 millimeters. Therefore, upon the road-induced vibration, each first inclined segment 221 and each second inclined segment 223 deform easily and smoothly because each first and second curved segments 224, 225 smoothly connect each corresponding first and second inclined segments 221, 223 with each corresponding connecting segment 222, so that the elastic arms does not break easily even under longtime use. As referred to FIGS. 4-6, two lateral sides of each first inclined segment 221, each connecting segment 222 and each second inclined segment 223 are curved so as to enhance the value of the elastic deformation of the frame 2.

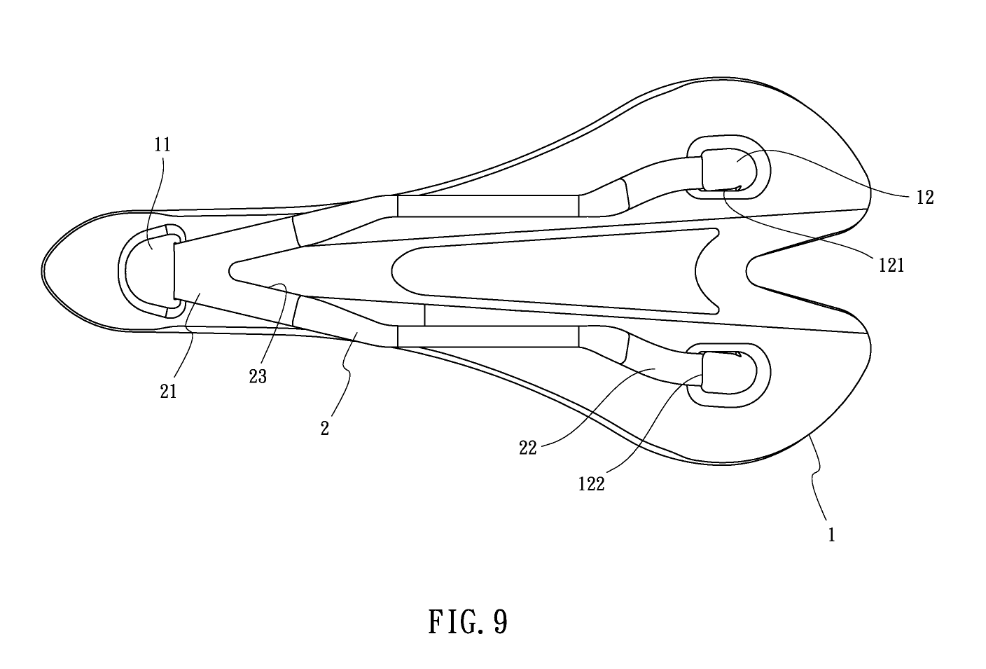

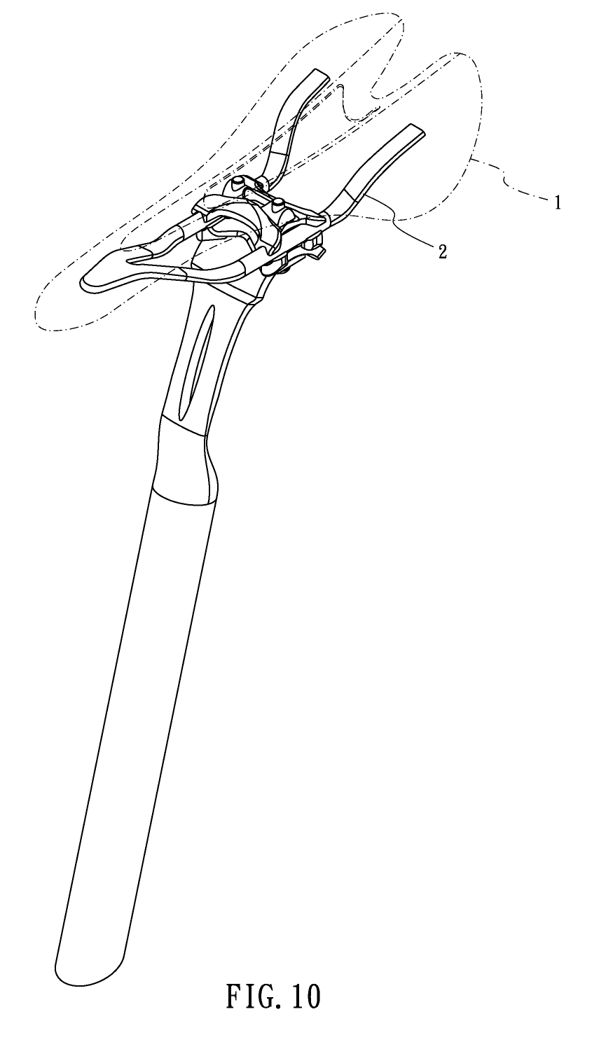

Referring to FIG. 2, a cushion space 23 is defined by the front assembling portion 21 and the two elastic arms 22. The cushion space 23 is opened and enlarged from the front assembling portion 21 toward the two elastic arms 22. The cushion space 23 provides a space to receive the two elastic arms 22 when the two elastic arms 22 deform. Further referring to FIGS. 8-9, when the rider sits on the seat 1, the rider's pelvis presses the seat 1 and the weight of the rider forces the frame 2 to sink; in the mean time, the two elastic arms 22 deform toward the cushion space 23 to absorb the force produced by the rider's weight; similarly, when the rider rides on the unsmooth road, the two elastic arms 22 deform toward the cushion space 23 to absorb the reaction force produced by the road-induced vibration. Referring to FIG. 10, a bicycle post (not numbered) is disposed at the cushion space 23 and positioned on the two elastic arms 22 securely.

Referring to FIG. 9, the seat 1 has a front positioning member 11 and two rear positioning members 12 defined at the bottom thereof Each rear positioning member 12 has a side positioning groove 121 and a front positioning groove 122 opened thereon. The two side positioning grooves 121 correspond to each other. The two front positioning grooves 122 correspond to the front end of the seat 1. Each side positioning groove 121 communicates with each corresponding front positioning groove 122. Upon the assembling of the seat 1 and the frame 2, the front assembling portion 21 is inserted into the front positioning member 11 firstly; and then, the two elastic arms 22 are selectively inserted into the rear positioning members 12 through the front positioning grooves 122 or the side positioning grooves 121; thereby, instead of using tools to assemble or disassemble the frame 2 to the seat 1, the rider only needs to press one end of the front assembling portion 21 and two ends of the elastic arms 22 so that the frame 2 is compressed; as a result, the front assembling portion 21 and the two elastic arms 22 of the frame 2 can be inserted into the front positioning member 11 and the rear positioning members 12 respectively.

Although the invention has been explained in relation to its preferred embodiment, it is to be understood that many other possible modifications and variations can be made without departing from the spirit and scope of the invention as hereinafter claimed.

What is claimed is:

1. A seat device for a bicycle comprising:
a seat;
a frame assembled to a bottom of the seat, the frame comprising a front assembling portion assembled with a front end of the seat, two elastic arms formed in a fork-shape extended from the front assembling portion to a rear end of the seat; and
each elastic arm comprising a first inclined segment, a connecting segment and a second inclined segment in an order from the front end of the seat to the rear end of the seat, each first inclined segment downwardly inclined from the front assembling portion toward each connecting segment, each first inclined segment and each second inclined segment having flat cross sections, each connecting segment having a circular cross section;
wherein when a rider rides on an unsmooth road, a reaction force produced by a road-induced vibration is delivered to the seat; and then, the seat shifts said force to the frame so that the frame deforms to absorb said force; as a result, the rider has a lower possibility in suffering damages caused by the road-induced vibration and the comfortableness of the rider is improved as well.

2. The seat device for a bicycle as claimed in claim 1, wherein each elastic arm comprises a first curved segment and a second curved segment; one end of each first curved segment is connected to each corresponding first inclined segment; another end of each first curved segment is connected to each corresponding connecting segment; for each first curved segment, a cross section at one end of the first curved segment is flat and turns into circular gradually toward another end of the first curved segment; one end of each second curved segment is connected to each corresponding second inclined segment; another end of each second curved segment is connected to each corresponding connecting segment; for each second curved segment, a cross section at one end of the second curved segment is flat and turns into circular gradually toward another end of the second curved segment.

3. The seat device for a bicycle as claimed in claim 1, wherein each connecting segment has a radius of 3.5 millimeters.

4. The seat device for a bicycle as claimed in claim 1, wherein a cushion space is defined by the front assembling portion and the two elastic arms; the cushion space is opened and enlarged from the front assembling portion toward the two elastic arms.

5. The seat device for a bicycle as claimed in claim 1, wherein the seat has a front positioning member and two rear positioning members defined at the bottom thereof; each rear positioning member has a side positioning groove and a front positioning groove opened thereon; the two side positioning grooves correspond to each other; the two front positioning grooves correspond to the front end of the seat; each side positioning groove communicates with each corresponding front positioning groove; the front assembling portion is inserted into the front positioning member and the two elastic arms are selectively inserted into the rear positioning members through the front positioning grooves or the side positioning grooves.

6. The seat device for a bicycle as claimed in claim 1, wherein two lateral sides of each first inclined segment, each connecting segment and each second inclined segment are curved.
